(19) United States
(12) Patent Application Publication
(10) Pub. No.: US 2010/0167006 A1
(43) Pub. Date: Jul. 1, 2010

(54) Molding

(75) Inventor: Uwe Langemann, Salzgitter (DE)

Correspondence Address: FOX ROTHSCHILD LLP, 997 Lenox Drive, Bldg. #3, Lawrenceville, NJ, 08648, US

(73) Assignee: METEOR GUMMIWERKE K.H. BADJE GMBH & CO. KG, Bockenem (DE)

(21) Appl. No.: 12/160,840

(22) PCT Filed: Dec. 1, 2006
(86) PCT No.: PCT/EP06/11542

§ 371 Date: Jul. 14, 2008

(30) Foreign Application Priority Data
Feb. 16, 2006 (DE) 20 2006 002 438.7

(51) Int. Cl. B32B 3/04

(52) U.S. Cl. 428/122

(57) ABSTRACT

A molding (1) composed of a base body, formed by means of an injection molding process, and a fastening device (13) which is connected thereto while it is being shaped, is intended to be plugged onto the web (3) of the bodywork of a vehicle. In order to achieve simple handling in terms of mounting but also a stable seat of the molding on the web (3), said molding is characterized by a U-shaped clamp insert (14) which is composed of plastic and which is in direct contact with the web (3), wherein the clamp insert (14) is itself placed in a metallic clamp part (15) and is arranged secured therein, and wherein the system which constitutes the fastening device (13) and is composed of the clamp insert (14) and clamp part (15) is integrated into the material of the aforesaid base body. A seat of the molding (1) on the web (3) is achieved which is permanently fixed by virtue of the elastic properties of the clamp part (15) and is secured by frictional engagement between the web (3) and the clamp insert (14).

The invention relates to a molding according to the preamble of claim 1.

The problem of efficiently fastening a molding composed of plastic to another mounting which fulfils a carrier function occurs basically in the entire field of the technology so that the fastening of sealing profiles, protection profiles or else decorative profiles to parts of a vehicle can merely be considered examples.

U.S. Pat. No. 6,546,683 discloses a method for fastening the trim in the window region of a vehicle, which trim has a globally U-shaped form whose free ends form inwardly directed webs, wherein a securing strip which is composed of plastic and is connected to a carrier component is provided, and a metallic securing clip can be locked to said securing strip. At the same time, spring arms are simultaneously integrally formed onto the securing clip and they are intended to engage in an elastic fashion behind the webs which are integrally formed onto the free ends of the trim and in this way they secure the trim. The illustrated method of fastening requires, as well as the adaptation of the trim, also a securing structure which is fixedly connected to the vehicle, interacts with the securing clip and is comparatively complicated.

DE 43 00 113 discloses, for the connection of a decorative panel to a carrying part, here a bumper, a U-shaped beveled portion tube being formed onto the latter, from which beveled portion a plurality of webs project, extending in the direction of the beveled portion. The webs are intended for insertion into slots on the decorative panel, wherein each slot is assigned a securing element which is determined by two angled components and is configured to interact with a securing clamp which is itself designed to receive and secure the aforesaid webs in a frictionally engaging fashion. This method of fastening a component also requires special adaptations both to the carrying part and to the component which is to be attached to it, while there is an additional loose part, specifically a metallic securing clamp. As result, this form of fastening is extremely specialized and its handling in terms of mounting is particularly work-intensive.

EP 0 862 699 discloses a profile seal which is intended for use in vehicle manufacture, in particular for plugging onto an edge web. Said profile seal is provided with a fastening device which is composed of a securing clamp which is manufactured from plastic, is globally U-shaped in cross section and is inserted into a metallic securing part, which also has a global U-shape. This fastening device is fixedly connected to the profile seal by encapsulation by injection molding with the material, wherein the space which is surrounded by the inner securing clamp is intended to receive the aforesaid edge web. A position, which is central viewed in a cross section, of the securing clamp within the securing part is provided by impressions on the securing part, on which impressions the facing outer sides of the securing clamp bear, wherein the free ends of the U-shape profiles of the securing part and of the securing clamp are designed to provide positively engaging protection against pulling out of these two components. In an approximately central region of the securing clamp, a web is formed on transversely with respect to said securing clamp, said web projecting into a slot on the securing part and bringing about positive engagement which is effective in the longitudinal direction of these two parts, with the result that in this direction also the securing clamp is centered within the securing part.

Against this background, the object of the invention is to configure a molding of the type specified at the beginning, with the aim of further improving, in particular stabilizing, the seat of the molding on an edge web of a carrier component or the like, accompanied by simple handling in terms of mounting. This object is achieved with such a molding by means of the features of the characterizing part of claim 1.

A clamp insert which is intended to enter into at least frictional engagement with the web-like component, for example the surrounding edge web of an opening of a vehicle, is fixedly connected to the molding in a manner known per se directly during the shaping of the molding. For example, the clamp insert can be inserted directly into a mold which is intended for the manufacture of the molding, with the result that within the scope of an injection molding process the clamp insert is partially integrated into the material of the molding and is given a stable seat. In each case, the clamp insert forms contact faces which, in the mounted state of the molding, are in contact with the aforesaid component so that frictional engagement which can be achieved in this way is conditioned by the pairing of materials of the contact faces but also by the pressure, acting on the clamp insert during an injection molding process, of the molding material which is to be molded, and is conditioned in particular by the elasticity of the molding. Adaptation work on the aforesaid web-like component is therefore dispensed with and the molding which is equipped in this way can be mounted directly by plugging on. A metallic clamp part, which also has a global U-shape in cross section and into which the clamp insert is plugged and in which it is secured, is also connected to the clamp insert.

This clamp part also has a strength-enhancing effect, and at the same time it provides elastic spring forces which bring about a pressing force, constant over time, between the aforesaid component and the faces of the clamp insert which are facing it. The clamp insert which is composed of a plastic or of an electrically nonconductible material serves, inter alia, to provide sufficient frictional engagement on the aforesaid component. At the same time it prevents electrochemically induced corrosion phenomena of the faces of the fastening device which are in contact with one another, on the one hand, and of the aforesaid component, on the other. Clamp inserts which are composed of plastic are known as such and are generally commercially available. This method of fastening can be used in different moldings, and sealing strips, protective strips and other profile strips are merely examples thereof. Spring tongues, which are completely integrated into the material of the molding and which exert a stabilizing influence on the clamp part, extend away from the clamp insert, and therefore on the outside. In particular, depending on the extent of the spring tongues, considerable stiffening of the clamp part and in this way also of the clamp insert occurs. This in turn stabilizes the securing forces which are active between the clamp insert and the aforesaid component, with the result that the molding also experiences a constant secure fastening over time.

The features of claim 2 are aimed at a specific spatial orientation of the spring tongues of the clamp part. This entails the advantage that at the same time improved protection against pulling out in terms of the fastening device being pulled out of the substance of the molding is provided at the same time.

The features of claims 3 and 4 are aimed at a configuration of the clamp part as such. Said clamp part can subsequently be integrated into a shell which is preferably composed of a plastic, for example polypropylene. However, coatings of elastomer materials are also possible. The shell can be applied in an injection molding process, but coating by means of a film which is bonded to the clamp part is also possible. Such a shell provides a protective function, for example against corrosive attacks on the metal of the clamp insert. Since the fastening device which is embodied in the present way is intended for insertion into a molding, in particular for connection to its material, the material of the shell can be selected as a function of the material of the molding, for example with the objective of improving the join between the clamp part on the one hand and the molding on the other, with the result that a connection is produced which is particularly resistant to loading and has a high degree of protection against pulling out.

The features of claim 5 are aimed at a particularly simple method of embodying the aforesaid spring tongues since said spring tongues are subsequently wall sections of the clamp part. At the same time, in this way recesses are produced within the aforesaid walls and said recesses are filled with the material of the molding during the encapsulation by injection molding. This provides further stabilization of the connection state of the clamp part and clamp insert.

According to the features of claim 6, the base body of the molding can be composed of an elastomer material. TPE (thermoplastic elastomer) and EPDM (ethylene/propylene diene terpolymer) are merely examples in this context.

According to the features of claim 7, the clamp insert is secured in an at least frictionally engaging fashion within the clamp part. Positively engaging securement, which is based, for example, on elastic latching can occur in all cases. In the mounted state, that is to say in the state of connection to the molding, there are additional securing forces which result from the partial encapsulation by injection molding with the material of the molding.

The features of claims 8 to 10 provide the advantage that the clamp insert experiences uniquely defined and, in particular, reproducible positioning within the clamp part, specifically viewed in the longitudinal direction of the clamp part. At the same time, by virtue of the dimensioning of the aforesaid spring tongues they can exert an elastic prestressing force on the walls or limbs of the clamp insert, which force is transmitted over a large surface. These spring tongues can advantageously be formed by wall sections of the clamp part which are only seen on the inside. The bearing of the spring tongues over a surface also provides the advantage of stiffening the profile of the clamp insert and therefore contributes to making available high pulling off forces which are stable even over time.

Since, according to the features of claim 11, the U-shaped cross section of the clamp insert which is intended to interact with the aforesaid component, which fulfils a carrier function, has a profile which tapers slightly in a conical shape in the direction of a profile base starting with an insertion gap, it is possible to ensure that after the aforesaid component has been plugged in contact can be produced between the component and the facing inner faces of the clamp insert in a way which brings about reliable frictional engagement over a large area.

The features of claims 12 and 13 provide the advantage that contact which is suitable for exerting a supporting effect is configured over a large area between the outer sides of the clamp insert and the facing inner sides of the clamp part. By virtue of the fact that the profiled sections which are formed in the free ends of the clamp insert and of the clamp part are integrated into the material of the base body of the molding, a further effect which secures the position of the fastening device within the molding is provided.

The features of claims 14 and 15 provide the advantage of stable positioning of the fastening device, wherein positive engagement, which is provided by the transverse profiles, is promoted by further openings in the clamp part, into which openings molding material passes during the process of encapsulation by injection molding which is aimed at shaping the molding, and said molding material exerts a securing effect.

From the aforesaid statements it is clear that a molding which is equipped according to the invention is prepared in a particular way for the sake of standardized mounting, specifically insofar as for this purpose all that is necessary is to provide, on a carrier component, merely one web, one flange or a comparable structure which is suitable for plugging on. No further measures have to be taken on the molding itself for the purpose of mounting, with the result that said molding is particularly suitable for use in mechanized production lines.

The invention will be explained in more detail below with reference to the exemplary embodiment which is represented schematically in the drawings. In said drawings:

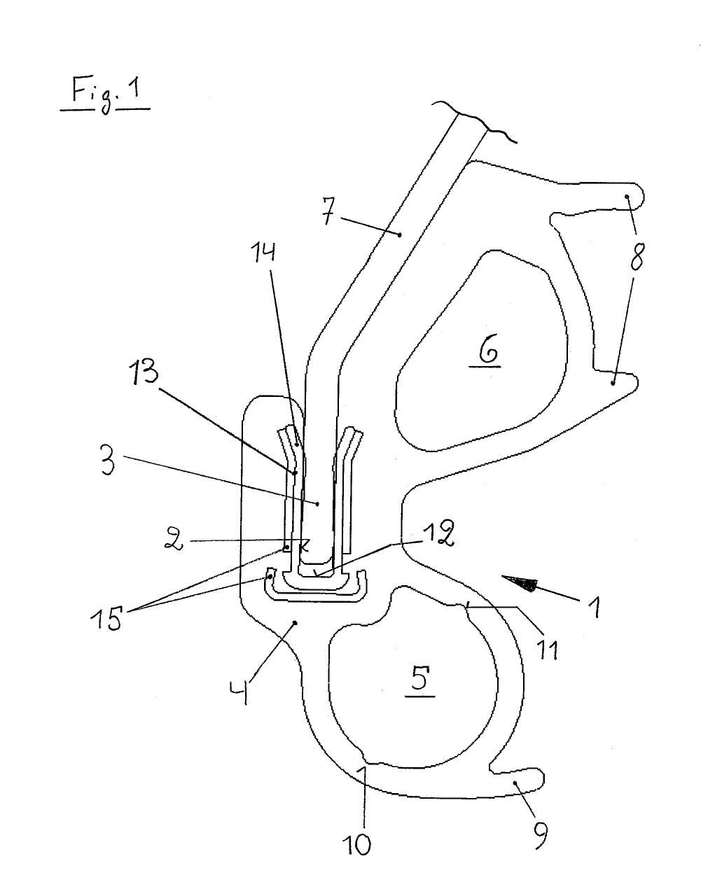

FIG. 1 is a cross-sectional illustration of a molding which is equipped with a fastening device according to the invention;

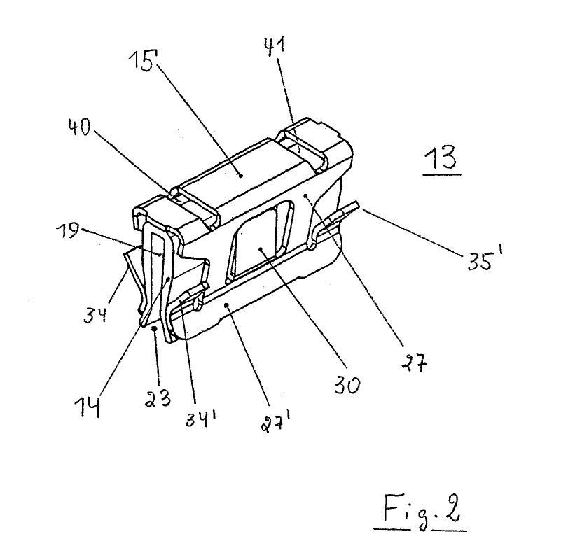

FIG. 2 is an isolated illustration of a perspective view of the fastening device according to the invention;

FIG. 3 is an illustration of the clamp part which is used in the fastening device, in a cross section corresponding to a sectional plane III-III in FIG. 8;

FIG. 4 is an illustration of the fastening device according to FIG. 2 in a side view;

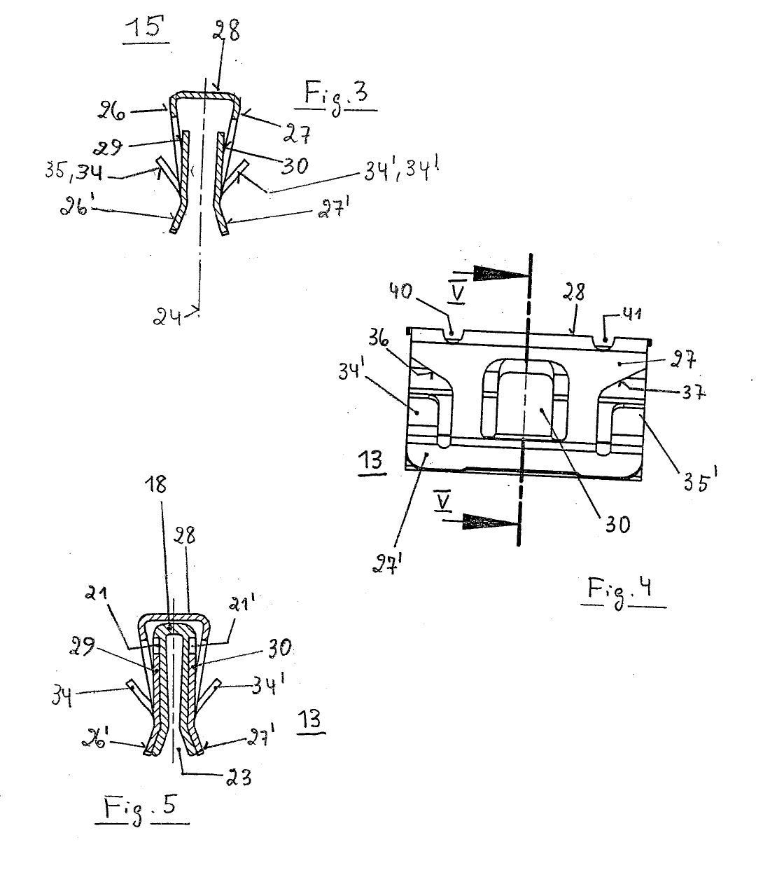

FIG. 5 is an illustration of a cross section of the fastening device corresponding to a sectional plane V-V in FIG. 4;

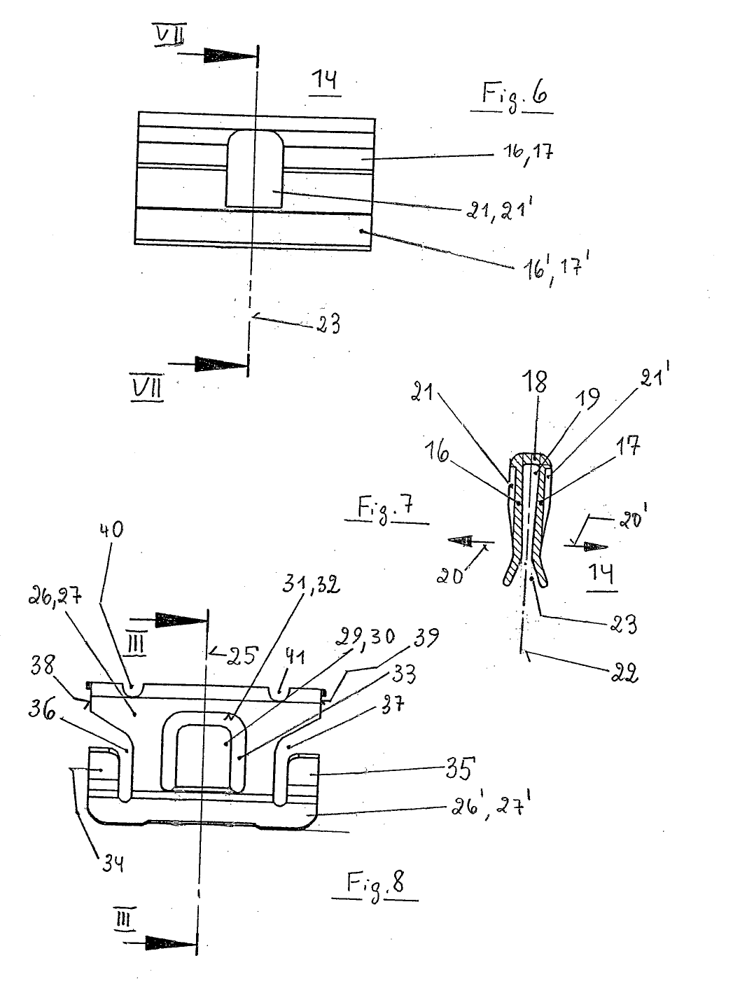

FIG. 6 is an isolated illustration of the clamp insert of the fastening device according to FIG. 2 in a side view;

FIG. 7 is an illustration of a cross section of the clamp insert corresponding to a sectional plane VII-VII in FIG. 6; and

FIG. 8 is an isolated illustration of the clamp part according to FIG. 2 in a side view.

In FIG. 1, a molding which is manufactured from an elastomer material, for example EPDM (ethylene/propylene diene terpolymers) or else TPE (thermoplastic elastomer), which is provided with a U-shaped receptacle 2 on its side which is on the left in the drawing.

A flange or web 3, which may be an integral component of the bodywork of a vehicle, for example an opening on the vehicle or else a door structure which is intended for closing this opening, is plugged into the receptacle. The molding can therefore be, for example, a sealing profile which is composed of a fastening part 4 which surrounds the receptacle 2 and onto which two hollow profiles 5, 6 are integrally formed. The web 3 forms, on its part projecting out of the receptacle, a beveled section 7 on whose side which is on the right in the drawing the hollow profile 6 bears, while the hollow profile 5 is arranged at a region of the fastening part 4 facing the end of the receptacle 2, at a distance from the hollow profile 6.

Both hollow profiles 5, 6 are equipped with sealing profiles 8, 9 on their sides facing away from the web 3 or the section 7, said sealing profiles 8, 9 being intended to interact with parts of the bodywork of a vehicle or of a door which are arranged fixedly or movably with respect to the section 7 and are not represented in the drawing. However, more details on this will not be given in the text which follows.

10, 11 denote weakened portions of the wall thickness lying diametrically opposite on the inside of the cross section of the hollow profile which is globally circular in cross section, which weakened portions in the wall thickness increase the elasticity of the hollow profile 5 in the direction of a receptacle base 12. The hollow profiles 5, 6, in particular the dimensioning of their wall thicknesses, viewed in the peripheral direction, are dimensioned so as to provide sufficient elasticity or a sufficient restoring capability. However, more details on this will not be given in the text which follows.

A fastening device 13 is essentially integrated into the material of the basic body of the molding, which fastening device is composed of a clamp insert 14 which is on the inside, i.e. enters into direct contact with the web 3, and a clamp part 15 which surrounds said clamp part 14 on the outside, wherein reference is made to the following FIGS. 2 to 8 for a more detailed description of these two components.

To this extent it is essential that the mounting of a molding 1 which is equipped with such a fastening device 13 is possible by simple plugging on onto the free end of the web 3, and in this context advantageous properties in terms of a stable seat of the molding 1 should result owing to the particular properties of the composite system composed of the fastening device 13 and the molding 1.

As is apparent from FIG. 2, both a clamp part 15 and the clamp insert 14 are conceived as global U-shaped components, with the clamp insert 14 being inserted into the clamp part 15. The fastening device 13 which is composed of these two components can be used to manufacture the molding 1 in a mold which is configured to shape said molding 1, and with a subsequent injection molding method said fastening device 13 can be integrated into the material of the molding at the location of the receptacle which was presented at the beginning in such a way that only the inner sides of the clamp insert 14 which are intended for direct contact with the web 3 are exposed.

As FIGS. 6 and 7 show in particular, the limbs 16, 17 of the clamp insert 14 bound a cross-sectional space 19 which widens slightly in a conical shape in the direction of the profile base 18.

Recesses 21, 21′ which lie opposite one another are integrally formed into the limbs 16, 17, specifically into their outer sides, specifically symmetrically both with respect to a vertical cross-sectional center plane 22 and with respect to a side view center plane 23 of the side view shown in FIG. 6.

The free ends of the limbs 16, 17 extend in the direction away from the cross-sectional plane 22, specifically at a symmetrical angle with respect to the latter. This results in an insertion gap 23 which tapers conically in the direction of the cross-sectional space 19, is intended for insertion of the web 3 and acts as a mounting aid.

As is shown by FIGS. 3 and 8 in particular, the clamp part 15 which is composed of metal also has a design which is symmetrical with respect to a vertical cross-sectional center plane 24 and a side view center plane 25. It is in turn possible to see two side limbs 26, 27 which firstly extend conically inward in the direction of the aforesaid cross-sectional planes starting from a profile base 28, the free ends 26′, 27′ being in turn beveled in the outward direction starting from the cross-sectional plane, in a way which is analogous to the free ends 16′, 17′ of the clamp insert 14.

29, 30 denote spring tongues which are formed within recesses 31, 32 of the limbs 26, 27 and are, in the nonstressed state shown in FIG. 3, bent inward in the direction of the cross-sectional center plane 24. The dimensions of these spring tongues 29, 30 are smaller than those of the aforesaid recesses.

As is apparent in particular in FIG. 8, the side view reveals an intermediate space 33 between the edges, facing one another, of the spring tongues 29, 30, on the one hand, and the recesses 31, 32, on the other.

The purpose of the spring tongues 29, 30 will be explained in more detail below.

34, 34′; 35, 35′ denote further spring tongues which, starting from the planes of the limbs 26, 27 and the approximate point where the beveled sections 26′, 27′ start, extend away from the cross-sectional plane 24 in the direction of the profile base 28. They are respectively located at the lateral ends of the two limbs 26, 27.

The spring tongues 34, 35; 34′, 35′ are therefore formed starting from the planar limbs 26, 27 and 26′, 27′, respectively, in a such way that slots 36, 37 are respectively integrally formed into the end sides 38, lying opposite one another, said slots 36, 37 extending in an initial region obliquely away from the profile base in the direction of the side view center plane 25 and subsequently parallel thereto as far as approximately the region in which the beveled sections 26, 27, 26′, 27′ start. The sections of the limbs which are separated off by the slots 36, 37 and extend essentially parallel to the side view of the center plane 25 form the aforesaid spring tongues 34, 35; 34′ 35′ which are beveled outward from the plane of the aforesaid limbs in a direction of the cross-sectional center plane 24.

Finally, slot-like breakthroughs in the profile base 28 which extend transversely with respect to the cross-sectional center plane 24 and which are located in the vicinity of the front-face-like ends of the clamp part 15 are denoted by 40, 41.

As has already been mentioned at the beginning, the clamp insert 14 is intended for insertion into the clamp part 15, with FIGS. 2, 4 and 5 showing this assembled state. In this context, the spring tongues 29, 30 of the clamp part 15 are received in the lateral recesses 21, 21′ of the clamp insert 14, in which case, in the state in which they are definitively plugged one into the other, abutment over a surface between the insides of the spring tongues 29, 30, including the beveled edges 26′, 27′, and the facing sides of the limbs 16, 17 and their beveled sections 16′, 17′ is brought about. This abutment can be configured in such a way that the plugged state occurs with slight elastic deformation of the parts of the clamp insert 14 and of the clamp part 15 which are in contact with one another.

It is apparent that the extent of the recesses 21, 21′ can be made larger than the extent of the spring tongues 29, 30 which are held in them so that, as is shown in particular in FIGS. 4 and 5, empty sections remain at the ends of the recesses 21, 21′ which face the profile base 18.

A fastening device 13 which is prepared in the way above and is composed of the clamp part 15 and the clamp insert 14 is subsequently inserted into a mold in which the shaping process of the molding 1 takes place, during which process the fastening device is very largely encapsulated by injection molding and only the U-shaped cross-sectional space 19 of the clamp insert 14 remains.

It is apparent that owing to the integration of the beveled sections 26, 26′, 27′, reliable integration into the material of the molding is brought about and this forms a high degree of protection against pulling out. It is also apparent that owing to the empty spaces, mentioned at the beginning, within the recesses 21, 21′, which empty spaces are filled with the material of the molding in the final state, the clamp insert 14 is reliably fixed within the clamp part 15 in a positively engaging fashion, and in addition the spring tongues 34, 35; 34′, 35′ bring about reliable anchoring which is effective in a positively engaging fashion.

Positively engaging anchoring in the material of the molding, in particular in the longitudinal direction of the fastening device 13, is brought about effectively by means of the breakthroughs 40, 41.

It is also apparent that in the mounted state of the molding there is no direct contact between the metallic web 3 on the one hand and the likewise metallic clamp part 15 on the other.

The plastic of the insertion part 14 can be selected with the aim of providing sufficient frictional engagement, sufficient stiffness, which ensures a stable seat of the molding, being provided by the virtue of the fact that the material of the molding, in particular its pressure, acts on the U-shaped fastening device over a large area. This is achieved in particular by the spring tongues which extend in the material of the molding, outward from the clamp part.

Finally, a molding which is prepared in the above way is extremely easy to mount.

1. A molding (1) composed of a base body, formed by means of a casting process or injection molding process, and a fastening device (13) which is connected to said base body while it is being shaped and is intended and designed to constitute a fastening of the molding (1) of a web-like component which fulfils a carrying function, wherein the fastening device (13) is composed of a U-shaped metallic clamp part (15) into which a U-shaped clamp insert (14) which defines a slot which is intended to receive the aforesaid component, enters into at least frictional engagement with the aforesaid component and is composed of a plastic, characterized in that spring tongues (34, 34′; 35, 35′) are integrally formed onto the clamp part (15) and extend away on the outside from this structure.

2. The molding as claimed in claim 1, characterized in that the spring tongues (34, 34′; 35, 35′) extend at an angle to a cross-sectional center plane (24), specifically away from this cross-section or center plane (24) viewed in the direction of a profile base (28).

3. The molding as claimed in claim 1, characterized in that the clamp part (15) is integrated at least partially into a shell composed of plastic.

4. The molding as claimed in claim 1, characterized in that the clamp part (15) is integrated at least partially into a film composed of plastic.

5. The molding as claimed in claim 1 characterized in that the spring tongues (34, 34′; 35, 35′) are formed by wall sections of the clamp part (15) which have an outwardly extending shape and are bounded partially by a slot.

6. The molding (1) as claimed in claim 1 characterized in that the aforesaid base body is composed of an elastomer material.

7. The molding (1) as claimed in claim 1 characterized in that the clamp insert (14) is held in an at least frictionally engaging fashion within the clamp part (15).

8. The molding (1) as claimed in claim 1 characterized in that inwardly extending spring tongues (29, 30) are integrally formed onto the inside of the clamp part (15), and in that, in the assembled state of the fastening device (13), these spring tongues are received in outside recesses (21, 21′) of the clamp insert (14).

9. The molding as claimed in claim 8, characterized in that the spring tongues (29, 30) are formed by inwardly formed wall sections of the clamp part (15) which are at least partially surrounded by a slot.

10. The molding as claimed in claim 8, characterized in that, in the assembled state of the fastening device (13), the spring tongues (29, 30) of the clamp part (15) extend in the planes of the walls or limbs (16, 17) of the clamp insert (14).

11. The molding as claimed in claim 1 characterized in that the U-shaped cross section (19) of the clamp insert (14) which is intended to interact with the aforesaid component has a profile which tapers slightly in a conical shape in the direction of its profile base (18) starting with an insertion gap (23).

12. The molding as claimed in claim 1 characterized in that the free ends, turned away from the respective profile base (18, 28), of the clamp insert (14) and of the clamp part (15) have sections (16′, 17′; 26′, 27′) which are beveled toward the outside.

13. The molding as claimed in claim 12, characterized in that the aforesaid beveled sections are integrated into the material of the aforesaid base body.

14. The molding as claimed in claim 1 characterized in that the clamp part (15) is provided with transverse profiles which, in conjunction with their integration into the material of the aforesaid base body, have the effect of constituting positive engagement perpendicular to a cross-sectional plane of the clamp part (15).

15. The molding as claimed in claim 1 characterized in that the fastening device (13) has a design which is symmetrical both with respect to a cross-sectional center plane (23, 24) and with respect to a side view plane (25).

16. The molding as claimed in claim 2 characterized in that the clamp part is integrated at least partially into a shell composed of plastic.

17. The molding as claimed in claim 2 characterized in that the clamp part is integrated at least partially into a film composed of plastic.

18. The molding as claimed in claim 2 characterized in that the spring tongues are formed by wall sections of the clamp part (15) which have an outwardly extending shape and are bounded partially by a slot.

19. The molding as claimed in claim 3 characterized in that the spring tongues are formed by wall sections of the clamp part (15) which have an outwardly extending shape and are bounded partially by a slot.

20. The molding as claimed in claim 4 characterized in that the spring tongues are formed by wall sections of the clamp part (15) which have an outwardly extending shape and are bounded partially by a slot.
